(19) United States
(12) Patent Application Publication
(10) Pub. No.: US 2005/0119838 A1
(43) Pub. Date: Jun. 2, 2005

(54) Analysis method of organic material properties and apparatus therefor

(75) Inventor: Nobutaka Itoh, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/989,458

(22) Filed: Nov. 17, 2004

(30) Foreign Application Priority Data
Nov. 28, 2003 (JP) 2003-398854

(51) Int. Cl. G06F 19/00

(52) U.S. Cl. 702/30

(57) ABSTRACT

After measuring material properties, a meshing means produces a numerical analysis model from material property data and structure data. A numerical analysis means carries out numerical analysis by using said numerical analysis model, material property data stored in a material property database, process data and analysis definition data. A subroutine is called up while said numerical analysis is carried out. Said subroutine obtains linear expansion coefficients, a moisture absorption expansion coefficient and others, during temperature rise and drop processes, corresponding to each temperature and absorbed moisture amount, from said material property database on the basis of said analysis definition data, and gives said linear expansion coefficients or linear expansion coefficients revised in accordance with an absorbed moisture amount to said numerical analysis means. Said numerical analysis means obtains the displacement of each element on the basis of said linear expansion coefficients and others and outputs the change of structure dimensions.

### BACKGROUND OF THE INVENTION

1. Field of the Invention

The present invention relates to a method for analyzing the properties of an organic material such as a thermosetting resin and an apparatus therefor, in particular to an analysis method for analyzing the change of structure dimensions caused by reaction hardening and moisture absorption and to an apparatus therefor.

2. Description of the Related Art

Simulation methods for predicting the behavior of a resin formed by injection molding and “warping” deformation of a molded product have hitherto been known (refer to Patent documents 1 and 2, for example).

The technologies described in such Patent documents 1 and 2 are those that predict the behavior of molten resin in a metal mold at the processes of filling, pressure keeping and cooling and thereafter predict the warping deformation of the resultant molded product on the basis of a fundamental expression formulated by the Finite Element Method.

Here, the Finite Element Method (FEM) is a means of predicting the overall behavior (in this case, deformation and stress distribution) of an object actually having complicated shape and properties by decomposing the object into small parts (elements) each having simplified shape and properties, approximately expressing the properties of each element by using each mathematical equation, combining the equations, and obtaining a solution that is compatible with all the equations.

The technologies described in the aforementioned Patent documents 1 and 2 are those that predict the behavior of a resin formed by injection molding and the “warping” deformation of a molded product and the warping or the like of a material for an electronic component or a printed circuit board is generally analyzed by using the aforementioned Finite Element Method as shown in FIG. 1.

(i) To measure the properties (hardness, a Young's modulus, the amounts of expansion and contraction at each temperature, and others) of a material that composes an electronic component, a printed circuit board or the like to be analyzed and then obtain the material property data.

(ii) To give the material property data and the structure data of a printed circuit board or the like to be analyzed and obtain structure model data (meshed element data and node data) and the material property data corresponding to each meshed element by a meshing means 10.

(iii) To give process data that defines the constraint conditions of a model, temperature, humidity, forced displacement, load, time, etc. and the changes of those, the structure model data and the material property data to a numerical analysis means 20, apply numerical analysis, and obtain the analysis results of the changes of the structure dimensions such as the “warping” deformation or the like of the printed circuit board or the like to be analyzed.

Patent document 1: JP-A No. 7-186228

Patent document 2: JP-A No. 8-230008

Thermosetting resin is used as a material for an electronic component or a printed circuit board in many cases.

The thermosetting resin is subjected to cross-linking reaction by moisture absorption or the radiation of ultraviolet ray, electron beam, laser beam or the like and hardens as a result of the cross-linking reaction. The cross-linking reaction is an irreversible process and forms a network structure that hinders the free motion of a polymer chain regardless of the temperature of the material. Further, the material contracts when cross-linking occurs.

Such cross-linking reaction contraction is determined by a temperature and a retention time at the temperature. For that reason, a polymer component under thermal load causes contraction warping during its use.

Further, the mechanical properties of such an organic material, such as hardness, a Young's modulus and a linear expansion coefficient, are changed by moisture absorption and also the volume thereof is increased by moisture absorption.

FIGS. 2A and 2B show the results of measuring the thermal reaction contraction.

FIG. 2A is a graph showing the thermal reaction contraction of a printed circuit board at the first cycle. In the figure, the horizontal axis represents temperature (° C.), the vertical axis represents expansion (μm), the curve X shows the expansion in the X direction and the curve Y shows the expansion in the Y direction. As shown in the figure, reaction contraction occurs at the time of the temperature rise of the first cycle.

FIG. 2B is a graph showing the results of measuring the thermal reaction contraction of an LSI encapsulation resin. In the figure, the horizontal axis represents temperature (° C.) and the vertical axis represents expansion (μm) in the same way as FIG. 2A and the figure shows the expansion at the first cycle and second and subsequent cycles.

As shown in the figure, reaction contraction occurs at the temperature rise of the first cycle but does not occur at the temperature rise of the second and subsequent cycles.

As mentioned above, in the case of thermosetting resin used as a material for printed circuit boards and LSIs, the structure change is not necessarily the same between the first cycle and the second and subsequent cycles and the dimensions after once subjected to temperature rise and drop do not necessarily return to the previous dimensions.

This is presumably because some portions that are not cross-linked remain and the cross-linking proceeds with the lapse of time at the portions.

As a result, there have been phenomena wherein, for example, unexpected dimensions are obtained when a printed circuit board is fabricated and then subjected to a temperature rise or the dimensions do not return to the original dimensions when it is subjected to a temperature drop again. Further, even in the state of retaining a material at a constant temperature, if some portions that are not cross-linked remain, the resin hardens and contracts with the lapse of time and resultantly the dimensions thereof change or deformation such as warping occurs. Furthermore, in addition to the aforementioned expansion and contraction caused by the temperature change, as mentioned above, the mechanical properties such as hardness, a Young's modulus, a linear expansion coefficient and the like are changed by moisture absorption and the volume also increases.

Up to now, the structure analysis that takes into consideration the properties of a material during temperature rise and drop processes, the properties thereof at each temperature and retention time, and the properties thereof such as expansion caused by the moisture absorption of a resin as mentioned above has not been implemented. As a consequence, the problem has been that an electronic component, a printed circuit board or the like deforms unexpectedly after it is fabricated and resultantly desired performances are not secured.

### SUMMARY OF THE INVENTION

The present invention has been established in view of the above situation and the object thereof is to make it possible to analyze the change of the structure dimensions of an organic material in consideration of the change of the material properties corresponding to temperature rise and drop processes, temperature and a retention time and an absorbed moisture amount as described above.

To solve the aforementioned problems, as one preferred mode, the present invention comprises the steps:

(1) to read out the property data of an organic material to be analyzed at each temperature from a material property database that stores the property data of organic materials including the linear expansion coefficient of the organic material at each temperature during a temperature rise process and the linear expansion coefficient thereof at each temperature during a temperature drop process, and numerically analyze the expansion and contraction properties of the organic material during the temperature rise and drop processes on the basis of the property data of the organic material including the linear expansion coefficients at each temperature,

(2) in the above item (1), to store in the material property database the linear expansion coefficient corresponding to the temperature gradient of the organic material to be analyzed or the linear expansion coefficient corresponding to a temperature and a retention time at the temperature of the organic material, read out the linear expansion coefficient corresponding to the temperature gradient or the linear expansion coefficient corresponding to the temperature and the retention time at the temperature from the material property database, and numerically analyze the expansion and contraction properties corresponding to the temperature gradient or the expansion and contraction properties of the organic material when the organic material is kept at a given temperature for a certain period of time, and

(3) in the above items (1) and (2), to store the moisture absorption expansion coefficient corresponding to each absorbed moisture amount in the material property database, read out the moisture absorption expansion coefficient corresponding to each absorbed moisture amount from the material property database, revise the linear expansion coefficient in accordance with the moisture absorption expansion coefficient, and numerically analyze the expansion and contraction properties of the organic material.

The present invention has made it possible: to numerically analyze the expansion and contraction properties of an organic material such as thermosetting resin during the temperature rise and drop processes, the expansion and contraction properties thereof corresponding to a temperature gradient, the expansion and contraction properties of the organic material when the organic material is kept at a given temperature for a certain period of time, or the expansion and contraction properties corresponding to a temperature and an absorbed moisture amount; and resultantly to analyze the warping and deformation of a structure including resin with a high degree of accuracy.

As a consequence, it becomes possible to prevent the occurrence of such a problem that an electronic component, a printed circuit board or the like that contains a resin material deforms unexpectedly after it is fabricated and thus desired performances cannot be obtained.

Other and further objects, features and advantages of the invention will appear more fully from the following description.

### BRIEF DESCRIPTION OF THE DRAWINGS

FIG. 1 is a block diagram showing a conventional example of numerical analysis by the Finite Element Method.

FIGS. 2A and 2B are graphs showing the results of measuring thermal reaction contraction.

FIG. 3 is a block diagram showing the analysis procedure of an embodiment according to the present invention.

FIGS. 4A and 4B represent the chart (1) showing an example of data stored in a material property database.

FIG. 5 is the chart (2) showing another example of data stored in a material property database.

FIG. 6 is a flowchart showing the analysis procedure in an embodiment according to the present invention.

FIG. 7 is a flowchart showing an example of a subroutine called up during the analysis processes shown in FIG. 6.

FIGS. 8A and 8B are the views showing an example of the results of analyzing warping caused by the hardening and contraction of a resin in an embodiment according to the present invention.

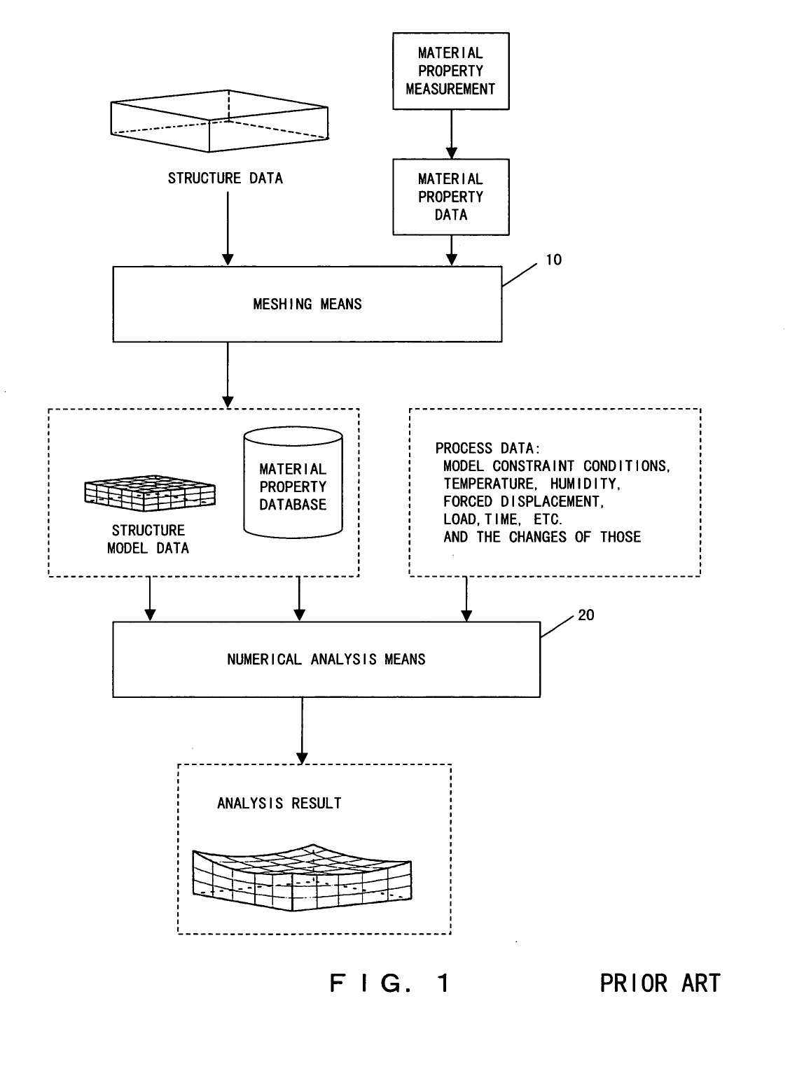

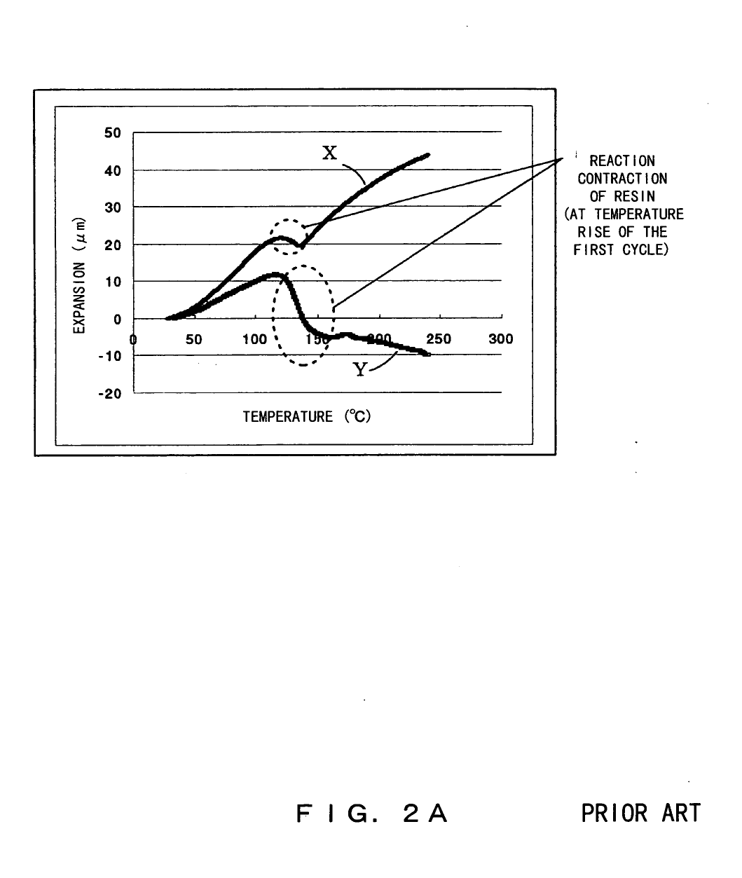

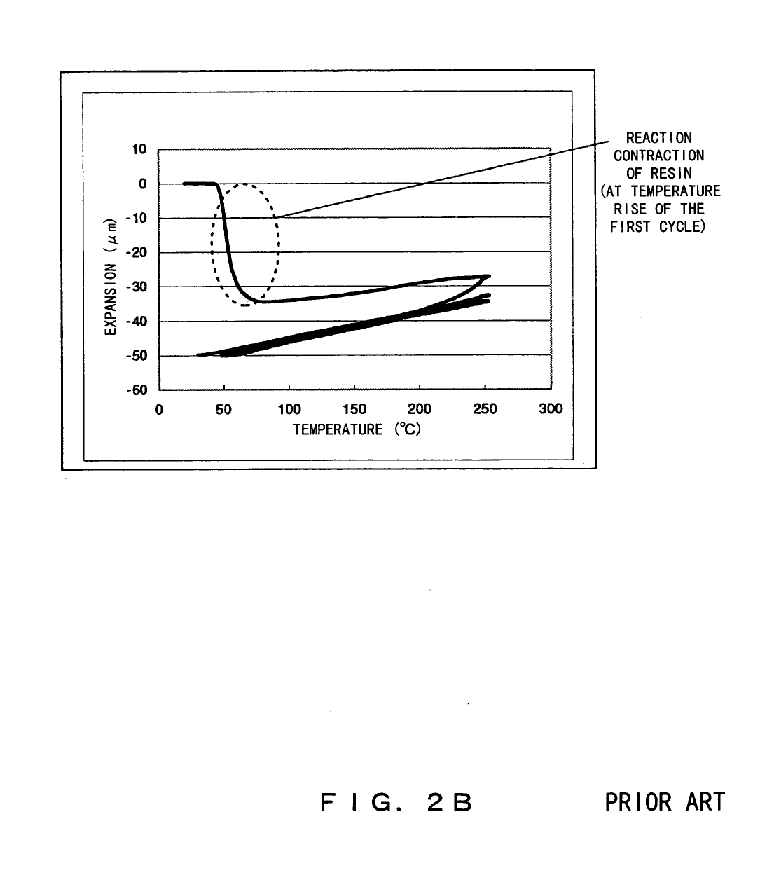

### DESCRIPTION OF THE PREFERRED EMBODIMENTS

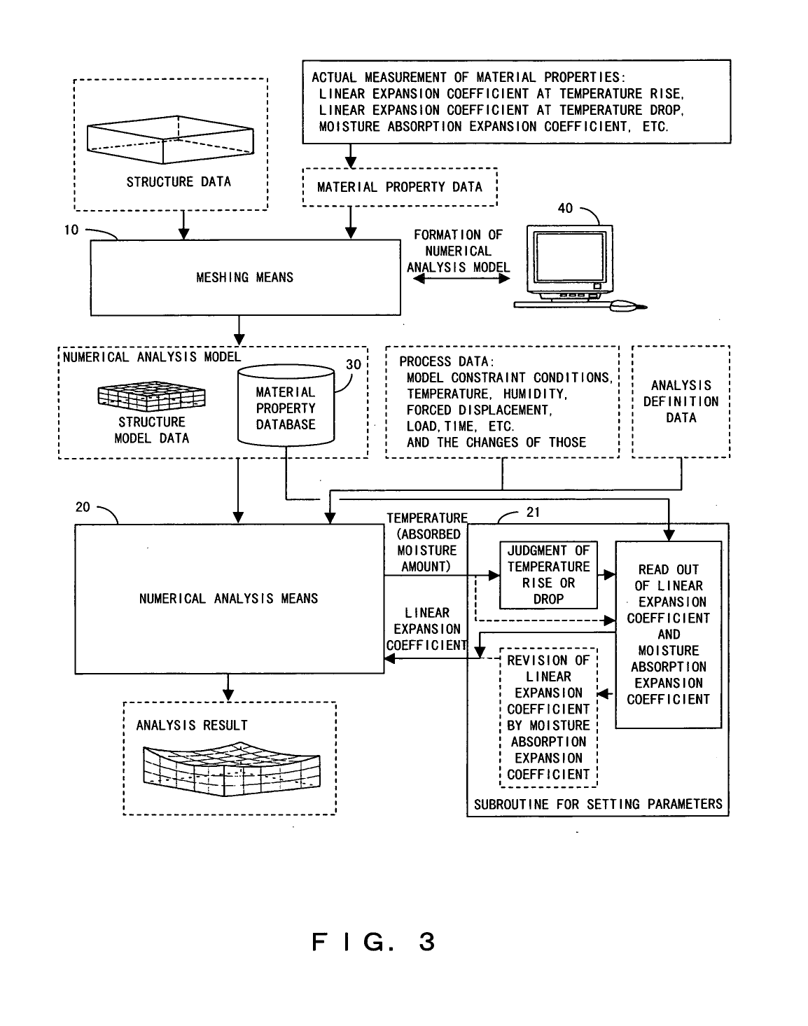

FIG. 3 is a block diagram showing the analysis procedure of an embodiment according to the present invention. Here, an information processor equipped with a processing unit, a memory, an external memory and the like can be used as an analyzer in the embodiment according to the present invention and the analysis processing that is described later can be implemented by using software.

The analysis processing of an embodiment according to the present invention is explained in reference to FIG. 3.

Firstly, material property data are obtained by measuring the properties (hardness, a Young's modulus, the amounts of expansion and contraction at each temperature, etc.) of a material composing an electronic component, a printed circuit board or the like to be analyzed as mentioned earlier. Here, in the embodiment according to the present invention, in addition to the aforementioned material properties which used to have been measured in the prior art, property data necessary to analyze the change of the material properties in accordance with temperature rise and drop processes, a temperature and a retention time and an absorbed moisture amount, such as “the amounts of expansion and contraction during the temperature rise and drop at the first cycle or the second and subsequent cycles,” “the amounts of expansion and contraction corresponding to a temperature and a retention time at the temperature,” “the amounts of expansion and contraction corresponding to a temperature and a temperature gradient,” “a moisture absorption expansion coefficient corresponding to an absorbed moisture amount,” “a Young's modulus corresponding to an absorbed moisture amount,” and the like are measured.

A numerical analysis model is produced by using a meshing means 10 by giving the aforementioned material property data and the structure data of an electronic component, a printed circuit board or the like to be analyzed.

That is, an analyzer, while having a conversation with the processing unit via an I/O unit 40, divides the structure data into elements, relates the above measured material properties to each of the elements, and produces a numerical analysis model comprising a structure model data (meshed element data and node data) and the material property data corresponding to each element. The material property data corresponding to each element is stored in a material property database 30. Here, the property data necessary to analyze the change of the material properties in accordance with temperature rise and drop processes, a temperature and a retention time, and an absorbed moisture amount as mentioned above are allocated to each element.

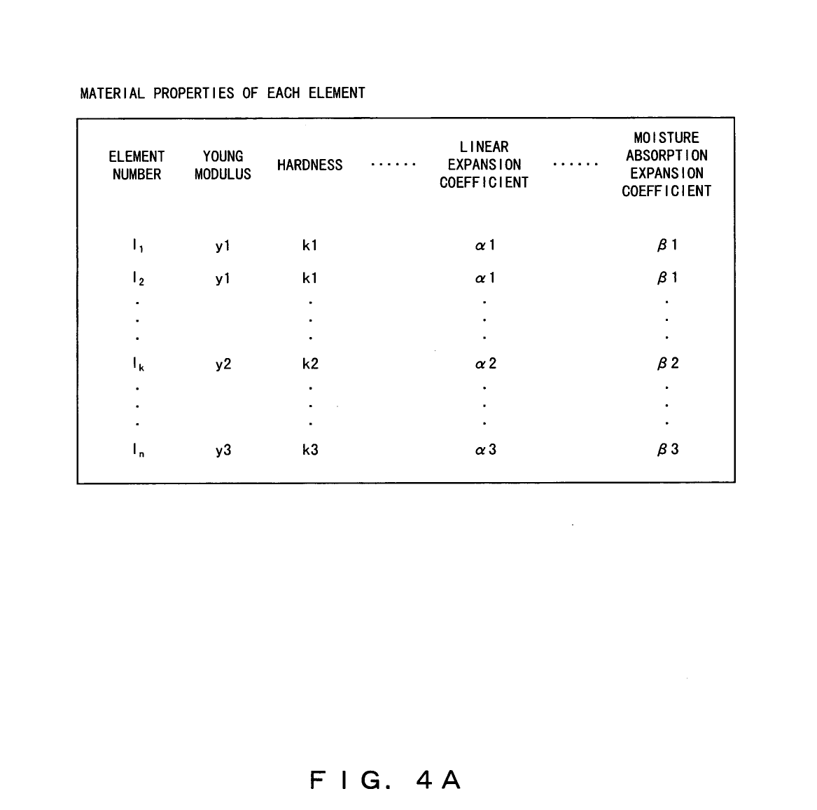

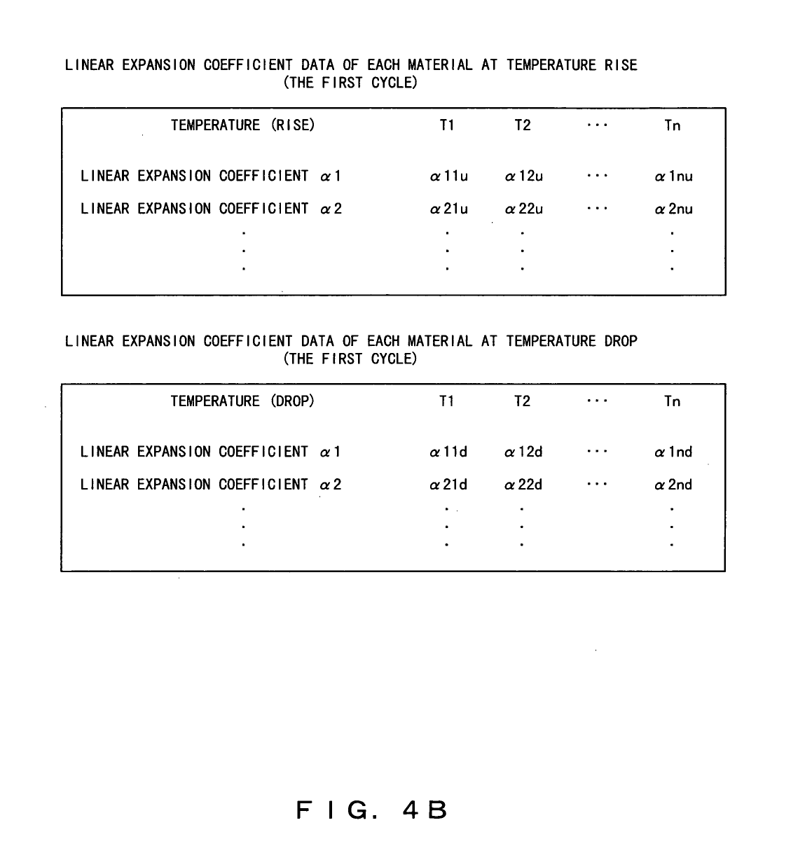

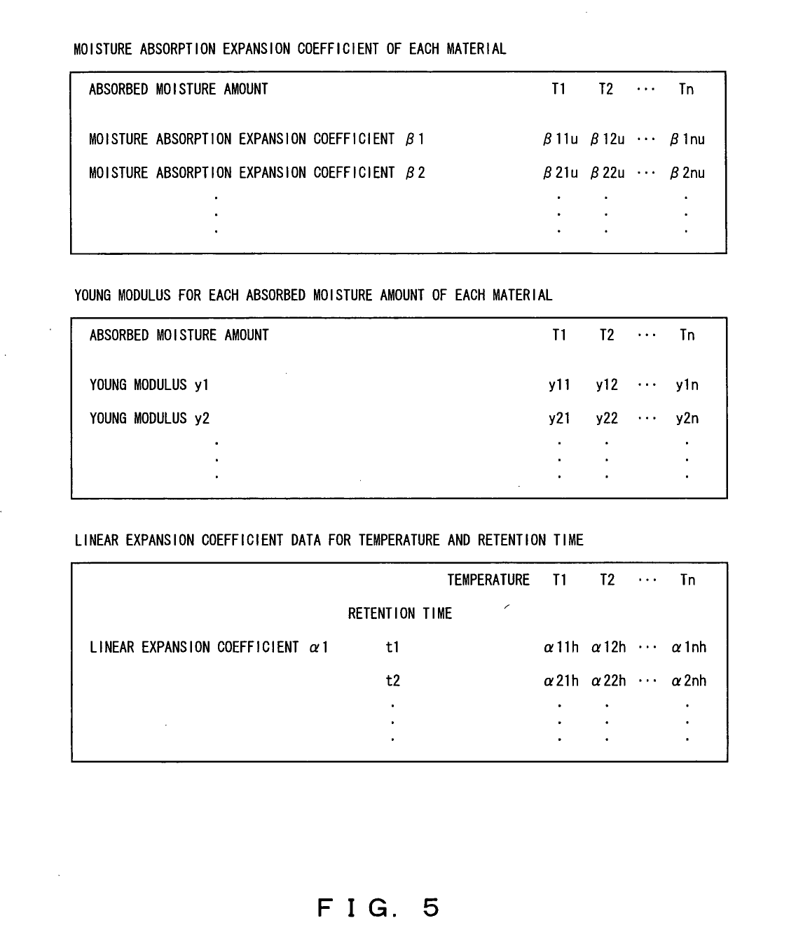

An example of data stored in the aforementioned material property database is shown in FIGS. 4A, 4B and 5. As shown in FIG. 4A, for each element, material property data including a Young's modulus, a hardness, a linear expansion coefficient, a moisture absorption expansion coefficient and the like are stored. Further, as shown in FIG. 4B, a linear expansion coefficient of each material at each temperature during temperature rise and drop (at the first cycle) is stored for each of the linear expansion coefficients α1, α2, and others in the material property data of each element shown in FIG. 4A. Likewise, the linear expansion coefficients at each temperature of the second and subsequent cycles are also stored.

In addition, other various property data required for analysis, such as a moisture absorption expansion coefficient for each absorbed moisture amount, a Young's modulus for each absorbed moisture amount, expansion and contraction amounts for each temperature and retention time, a linear expansion coefficient for each temperature and temperature gradient, and the like are stored as shown in FIG. 5 for example.

As shown in FIG. 3, in a numerical analysis means 20, numerical analysis is carried out by using the aforementioned structure model data (meshed element data and node data), the material property data corresponding to each element, the process data and analysis definition data, those latter two being described later. In the embodiment according to the present invention, a subroutine 21 is provided for setting parameters that are called up during the implementation of the numerical analysis and when analysis is carried out according to the present invention, the subroutine 21 is called up during the implementation of the numerical analysis and the analysis proceeds on the basis of the analysis definition data.

(i) Process Data

Data that define the state of environment surrounding a material to be analyzed, such as the constraint conditions of a model, temperature, humidity, forced displacement, load, time and others, and the changes of those.

(ii) Analysis Definition Data

Data that define the material properties and the like necessary to analyze the changes of the material properties and the like corresponding to temperature rise and drop processes, a temperature and a retention time and an absorbed moisture amount.

Note that, in the above process data, the temperature, humidity, load, displacement that are mentioned above are set so as to be constant or increase or decrease gradually, the aforementioned subroutine 21 is called up during the implementation of numerical analysis, and the analysis proceeds on the basis of the analysis definition data defined in the above item (ii).

That is, as shown in FIG. 3, data such as temperature and others are given from the numerical analysis means 20 to the subroutine 21 during the implementation of numerical analysis, and the subroutine 21 determines, for example, the rise or drop from the above temperature, reads the material property data from a material property database 30 on the basis of the analysis definition data defined in the item (ii), obtains the linear expansion coefficient and others at each temperature, and gives them to a numerical analysis program.

Further, in the case where analysis is carried out in consideration of an absorbed moisture amount, the numerical analysis means 20 obtains an absorbed moisture amount at each time and gives it together with the temperature to the subroutine 21. The subroutine 21 reads material property data based on a temperature and an absorbed moisture amount from the material property database 30 on the basis of the analysis definition data of the item (ii), obtains a linear expansion coefficient and others at each temperature and absorbed moisture amount, and gives them to a numerical analysis program.

The numerical analysis means 20 obtains the displacement of each element for temperature change, absorbed moisture amount change and others on the basis of the linear expansion coefficient and others and outputs the change of the structure dimensions as the analysis result as shown in FIG. 3.

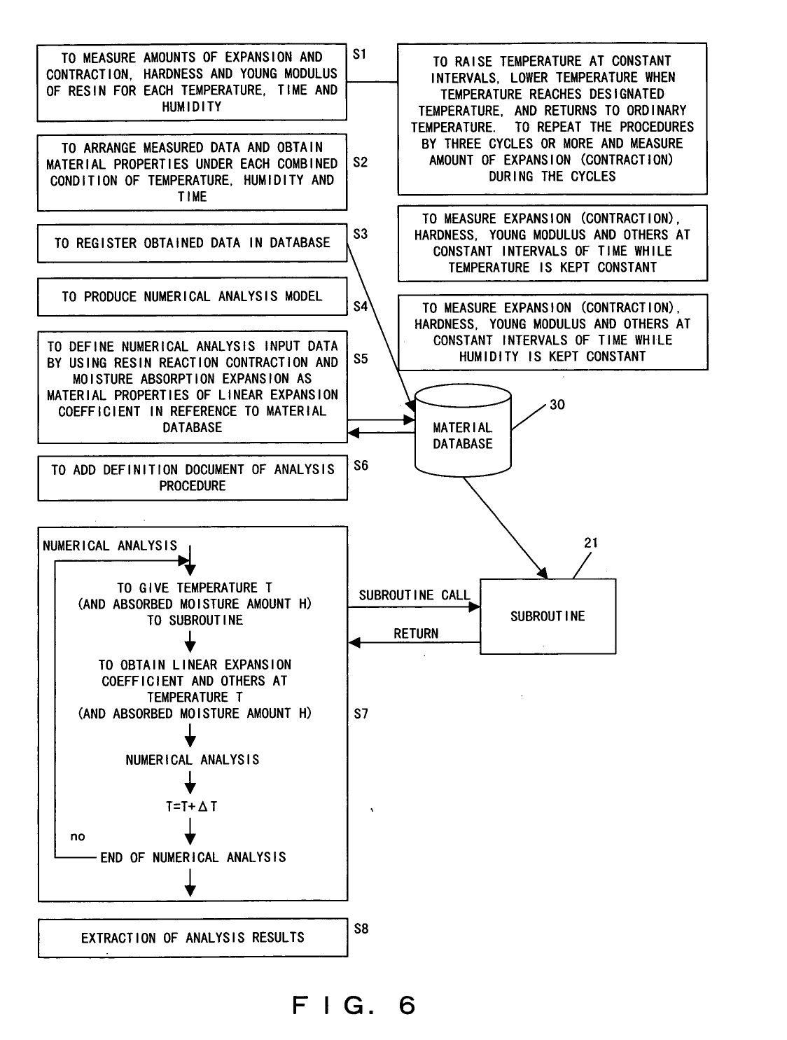

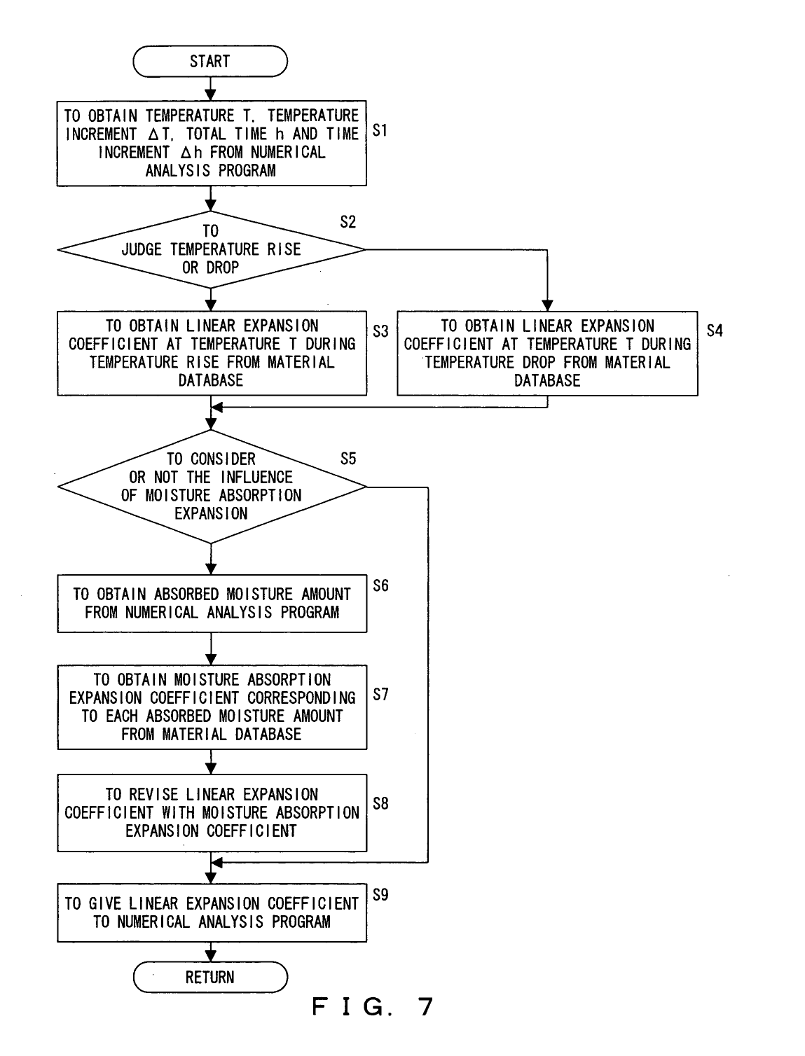

FIG. 6 is a flowchart showing the analysis procedure in an embodiment according to the present invention and FIG. 7 is a flowchart showing an example of a subroutine. The processing of an embodiment according to the present invention is explained on the basis of the figures.

In FIG. 6, firstly the amounts of expansion and contraction, hardness and a Young's modulus of a resin for each temperature, time and humidity are obtained by actual measurement (step S1). In the measurement, the temperature is raised at constant intervals, lowered when the temperature reaches a designated temperature, and returned to the ordinary temperature. The procedures are repeated by three cycles or more and the amounts of expansion and contraction are measured during the cycles. Further, the amounts of expansion and contraction, hardness, a Young's modulus and others are measured at constant intervals of time while temperature is kept constant. Furthermore, the amounts of expansion and contraction, hardness, a Young's modulus and others are measured at constant intervals of time while humidity is kept constant. Those measurements are carried out for each temperature and humidity.

Next, the measured data are arranged and material properties under each combined condition of temperature, humidity and time are obtained (step S2). The obtained data are registered in the material property database 30 (step S3).

Subsequently, a numerical analysis model comprising structure model data and material property data is produced in reference to the material property database 30 as mentioned earlier (step S4) and numerical analysis input data are defined by using resin reaction contraction and moisture absorption expansion as material properties of linear expansion coefficient (step S5).

That is, whether or not the influences of reaction contraction and moisture absorption are taken into consideration is judged and, when analysis is carried out while the influences are taken into consideration, for example, following definitions are employed.
(1) In the case of considering reaction contraction,
(i) to define that analysis is carried out by obtaining a linear expansion coefficient from a subroutine,
(ii) to define a temperature, a temperature increment plus time and a time increment during analysis,
(iii) to define whether input temperature is the passage temperature of the first cycle or the second cycle; for example, in the case of the passage temperature of the first cycle, linear expansion coefficients are allocated as follows,
   to allocate the linear expansion coefficient at a temperature before contraction,
   to allocate the linear expansion coefficient at a temperature during contraction,
   to allocate the linear expansion coefficient at a temperature after contraction.

In the same way, parameters necessary for analysis, such as each linear expansion coefficient during a temperature drop process, the moisture absorption expansion coefficient for each absorbed moisture amount, the Young's modulus for each absorbed moisture amount, the amounts of expansion and contraction for each temperature and retention time, and others, as mentioned earlier are allocated. Likewise, also in the case where input temperature is the passage temperature of the second cycle, parameters are allocated respectively in the same way.
(2) In the case of considering the influence of a moisture absorption expansion coefficient
(i) to define that analysis is carried out by revising a linear expansion coefficient on the basis of a moisture absorption expansion coefficient using a subroutine,
(ii) to define a temperature and a temperature increment during analysis,
(iii) to define a linear expansion coefficient, a Young's modulus, a moisture absorption expansion coefficient and others used in the subroutine;
in the case of considering the moisture absorption expansion coefficient too, parameters are allocated respectively in the same way as described above as long as the input temperature is of the first cycle,
(iv) to define that moisture absorption analysis is carried out for each temperature and retention time in a numerical analysis program.

On the basis of the above definitions, the document on the definition of the analysis procedure is added to the numerical analysis program and the numerical analysis processing is carried out (steps S6 and S7).

In the numerical analysis processing, the numerical analysis program calls up the subroutine 21 as shown in FIG. 6 and gives the temperature T (the absorbed moisture amount H is further added when moisture absorption analysis is carried out) and the temperature increment ΔT to the subroutine 21. Then, the numerical analysis program obtains the linear expansion coefficient at the temperature T (and the absorbed moisture amount H) from the subroutine 21, implements numerical analysis processing at the temperature on the basis of the linear expansion coefficient, and increases (or decreases) the temperature T by a determined value ΔT. The above processing is repeated until the numerical analysis terminates and thus the analysis results are obtained.

FIG. 7 is a flowchart showing an example of processing in the subroutine.

Firstly, the temperature increment ΔT is obtained from the numerical analysis program and whether the temperature rises or lowers is judged (steps S1 and S2).

If the temperature rises, the linear expansion coefficient corresponding to the temperature T at the time of the temperature rise is obtained from the material property database 30. On the other hand, if the temperature lowers, the linear expansion coefficient corresponding to the temperature T at the time of the temperature drop is obtained from the material property database 30 (steps S3 and S4). In this event, the relevant linear expansion coefficient is obtained in accordance with whether the temperature rise and drop defined in the aforementioned analysis definition are of the first cycle or the second and subsequent cycles.

Successively, whether or not the influence of moisture absorption expansion is taken into consideration is determined on the basis of the aforementioned analysis definition (step S5) and, when the influence of moisture absorption expansion is not taken into consideration, the procedure goes to the step S9 and the aforementioned linear expansion coefficient is given to the numerical analysis program.

On the other hand, when the influence of moisture absorption expansion is taken into consideration, the absorbed moisture amount is obtained from the numerical analysis program and the moisture absorption expansion coefficient and Young's modulus corresponding to the absorbed moisture amount are obtained from the material property database 30 (steps S6 and S7).

Thereafter, the linear expansion coefficient is revised with the moisture absorption expansion coefficient and Young's modulus corresponding to the absorbed moisture amount and the revised linear expansion coefficient is obtained (step S8) and given to the numerical analysis program (step S9).

Here, though the numerical analysis corresponding to the temperature rise and drop processes and the absorbed moisture amount is shown in the above flowchart, it is also acceptable to obtain, from the material property database 30, the property data such as the amounts of expansion and contraction corresponding to a retention time at a temperature, the amounts of expansion and contraction corresponding to a temperature gradient and others on the basis of the analysis definition defined as mentioned above and to numerically analyze the change of the structure dimensions of a resin corresponding to a temperature and a retention time, the change of the structure dimensions of a resin corresponding to the change of a temperature gradient and others.

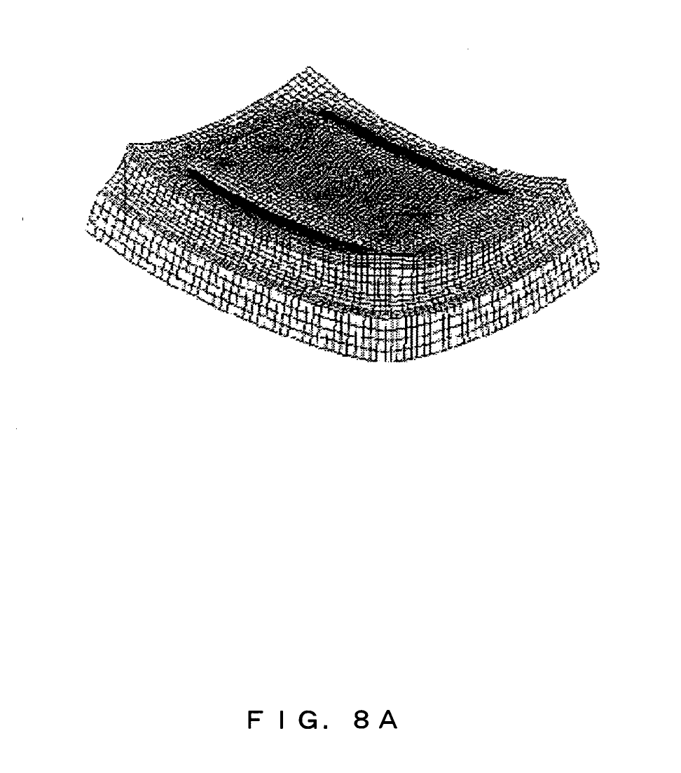

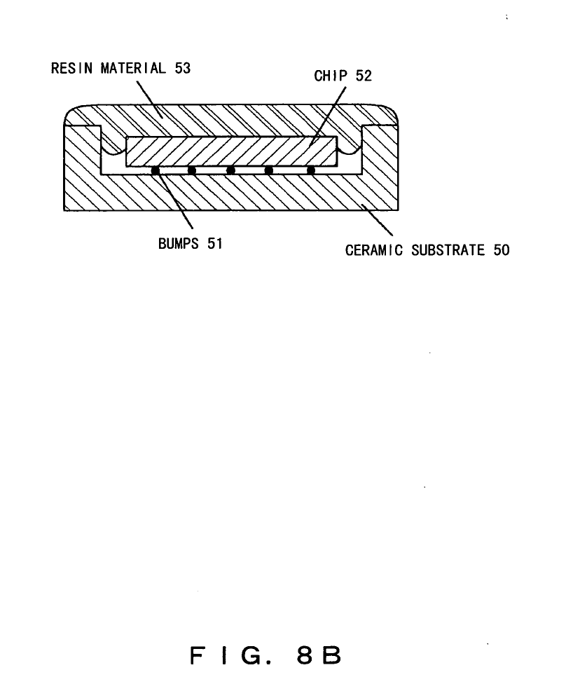

FIG. 8A is a view showing an example of the results of analyzing warping caused by the hardening and contraction of a resin, the results being obtained by the analysis in an embodiment according to the present invention. The figure shows an example of the warping of an electronic component fabricated by attaching a chip 52 to a ceramic substrate 50 with bumps 51 interposed in between and covering them with a resin material 53 as shown in FIG. 8B.

As shown in the figure, by the embodiment according to the present invention, it has become possible to numerically analyze deformation such as warping caused by the hardening and contraction of the resin material 53 with a high degree of accuracy and to analyze beforehand unexpected deformation caused by the hardening and contraction of an electronic component, a printed circuit board or the like.

The foregoing invention has been described in terms of preferred embodiments. However, those skilled, in the art will recognize that many variations of such embodiments exist. Such variations are intended to be within the scope of the present invention and the appended claims.

1. A method for analyzing the properties of an organic material, comprising:
reading out the property data of said organic material to be analyzed at each temperature from a material property database that stores the property data of organic materials including the linear expansion coefficient of said organic material at each temperature during a temperature rise process and the linear expansion coefficient thereof at each temperature during a temperature drop process; and
numerically analyzing the expansion and contraction properties of said organic material during the temperature rise and drop processes on the basis of the property data of said organic material including the linear expansion coefficient at each temperature.

2. A device for analyzing the properties of an organic material, comprising:
a material property database for storing the property data of organic materials including the linear expansion coefficient of said organic material to be analyzed at each temperature during a temperature rise process and the linear expansion coefficient thereof at each temperature during a temperature drop process, and
a numerical analysis unit for analyzing the expansion and contraction properties on the basis of the property data of said organic material, wherein
said numerical analysis unit reads out said property data at each temperature from said material property database; and
numerically analyzes the expansion and contraction properties of said organic material during the temperature rise and drop processes on the basis of said linear expansion coefficient at each temperature.

3. A device for analyzing the properties of an organic material according to claim 2, wherein:
said material property database stores the linear expansion coefficient corresponding to the temperature gradient of said organic material to be analyzed or the linear expansion coefficient corresponding to a temperature and a retention time at the temperature of said organic material;
said numerical analysis unit reads out said linear expansion coefficient corresponding to the temperature gradient or said linear expansion coefficient corresponding to said temperature and retention time at said temperature from said material property database; and
numerically analyzes the expansion and contraction properties corresponding to a temperature gradient or the expansion and contraction properties of said organic material when said organic material is kept at a given temperature for a certain period of time.

4. A device for analyzing the properties of an organic material according to claim 2, wherein:
said material property database stores the moisture absorption expansion coefficient corresponding to each absorbed moisture amount;
said numerical analysis unit reads out said moisture absorption expansion coefficient corresponding to each absorbed moisture amount from said material property database, revises said linear expansion coefficient in accordance with said moisture absorption expansion coefficient, and numerically analyzes the expansion and contraction properties of said organic material.

5. A recording medium storing a program directing a computer to analyze the properties of a resin, read out material properties from a material property database that stores the property data of organic materials including the linear expansion coefficient of said organic material to be analyzed at each temperature during a temperature rise process and the linear expansion coefficient thereof at each temperature during a temperature drop process, and numerically analyze the expansion and contraction properties of said organic material, the program directing the computer to realize a process comprising: reading out property data at each temperature from said material property database and numerically analyzing the expansion and contraction properties during the temperature rise and drop processes of said organic material on the basis of said linear expansion coefficient at each temperature.
